(19) United States
(12) Patent Application Publication
(10) Pub. No.: US 2021/0078889 A1
(43) Pub. Date: Mar. 18, 2021

(54) DEVICE FOR PURIFYING DRINKING WATER

(71) Applicant: instrAction GmbH, Mannheim (DE)

(72) Inventors: Martin Welter, Neckargemünd (DE); Christian Meyer, Schwetzingen (DE); Kristian Lungfiel, Wiesbaden (DE)

(21) Appl. No.: 16/963,726

(22) PCT Filed: Jan. 23, 2019
(86) PCT No.: PCT/EP2019/051650

§ 371 Date: Jul. 21, 2020

(30) Foreign Application Priority Data
Jan. 24, 2018 (DE) 202018100396.8

(51) Int. Cl. C02F 9/00; B01D 61/02; B01D 61/14; C02F 1/00

(52) U.S. Cl. CPC C02F 9/005; B01D 61/025; C02F 1/683; C02F 1/008; B01D 61/145

(57) ABSTRACT

A device for the multi-stage, modular purification of drinking water is described, wherein a module comprises a chelating gel or a chelating and a bactericidal gel for heavy metal removal and/or for heavy metal removal and bacterial removal.

The present application relates to a device for the multi-stage, modular purification of drinking water, wherein one module comprises a chelating gel or a chelating and bactericidal gel for the removal of heavy metal or for the removal of heavy metal and bacteria.

Due to the increasing needs of a growing world population, globally increasing environmental pollution, and increased quality requirements, the importance of water purification cannot be underestimated.

The quality of water, especially drinking water, can be affected by a large number of very different, partially harmful, contaminants. Time and again, especially heavy metals from pipe systems (especially lead), from agriculture (for example, cadmium), from coal-based electricity (mercury), or from natural sources (zinc, uranium, lanthanides) give cause for concern.

On the other hand, a large number of organic micropollutants, predominantly of anthropogenic origin, are found in drinking water. The most prominent representatives here include hormones (originally used for contraception) or residues of drugs or their degradation products, or agrochemicals.

Bacteria constitute a third group of undesired substances in drinking water. They often come from domestic water treatment devices themselves, or—especially in warmer parts of the world—from the pipe system.

The greatest danger these bacteria represent is to infants and young children or people with weakened immune systems, such as the elderly, for example.

In some countries, “chlorine” (hypochlorite) is added to the drinking water for disinfection and to kill the bacteria. This does ensure sterility, but affects the taste of the water significantly.

Other undesirable, although not harmful, components of water are in high concentrations of calcium and magnesium, which as hardness minerals, are responsible for making the water hard. Low concentrations are not only safe, but on the contrary, are beneficial to human health. But in high concentrations (high water hardness), calcium and magnesium produce a marked deterioration in the taste, as well as unwanted “water stains” in the kitchen and bathroom, or so-called boiler scale in water heaters (boilers) and cookware.

A large number of different, partly complementary devices for the purification of drinking water are on the market. In some cases, the equipment offered combines different methods of water purification, but leaves gaps in terms of the complete elimination or removal of the individual pollutants or classes of pollutants. At the same time, many of the established technologies have distinct disadvantages, such as low capacity, poor yield, additional contamination, high energy consumption, noise pollution from pumps, etc.

Reverse osmosis (RO) uses a membrane through which the water to be purified is pumped under high pressure to remove pollutants. Not only pollutants, but also important minerals are left behind and are concentrated again in the retentate. This method has many disadvantages for drinking water treatment, such as high water loss (>80% retentate), the high operating pressures that must be provided by an additional pump (along with high energy consumption and noise pollution), and not least, demineralisation, which partially must be reversed by the subsequent addition of calcium and magnesium. Despite these numerous disadvantages, reverse osmosis is widely used for point-of-use water purification.

The ultrafiltration frequently used in industrial food processing applications (wine and beer production) removes suspended matter and bacteria with relative reliability, but is not suitable for removing heavy metals or “chlorine”. Organic micropollutants are also not addressed, or if so, only very poorly.

Activated carbon is used in many household water purifiers, primarily to remove the “chlorine” taste and to remove organic micropollutants at the same time. Activated carbon does not bind heavy metals, does not reduce the water hardness, and due to its structure, is very susceptible to bacterial growth (biofilm formation), which in turn can lead to contamination of the drinking water with bacteria and their metabolites (“enterotoxins”).

For example, the cartridge commercially available under the name MetCap-T for the removal of heavy metals is filled with a chelating resin (instrAction MetCap), the production of which is demonstrated in DE 10 2014 012 566 A1 and DE 10 2016 007 662 A1. The application in a cartridge is also demonstrated by way of example in DE 102016007662 A1.

Due to its chelating properties, the MetCap-T resin binds heavy metals almost exclusively. Alkali and alkaline earth metals are not bound at all or are bound only very weakly due to their much lower complex binding constants and are displaced by them in the presence of heavy metals. This selectivity is exactly the reverse of that for the ion exchangers that are used for softening.

In addition to the property of a MetCap-T resin type to bind all heavy metals in a high capacity and irreversibly, a MetCap-T variant (as demonstrated in the German application 10 2017 007 273.6) removes bacteria at the same time, that is, it has a bactericidal effect in addition to its function as a heavy metal absorber.

Particle filters are often installed in the input side of water purification devices to remove suspended matter and particles from the tap water. They are used primarily to protect the rest of the devices from clogging and thus to prevent increased pressure and reduced productivity.

Ion exchangers as part of water softening modules are used to reduce water hardness by removing calcium and magnesium. However, these ion exchangers do not address micropollutants, just as they do not address chlorine or bacteria; on the contrary, they are often affected by biofilm formation. Another disadvantage is their low capacity, especially in hard water.

Just where the use of water softening modules is particularly indicated, the capacity of the ion exchange resins is exhausted rather quickly. Of all the water purification technologies, the ion exchanger is by far the most likely to require regeneration. This is usually done by rinsing with concentrated saline.

In addition to calcium and magnesium, ion exchangers also bind heavy metals. But the more the binding capacity is exhausted, the latter are displaced by the much higher concentrated calcium and magnesium ions and eventually concentrated in the eluate as a result. Ultimately, the ion exchanger lacks the selectivity for heavy metals over calcium and magnesium. Since the latter are in direct competition with the heavy metals, they are superior with respect to the binding places because of their far higher concentration in simple ion exchange.

In contrast, the aforementioned MetCap-T resin binds heavy metals selectively and with a strong preference and allows the unhealthy calcium and magnesium ions to pass largely unbound.

Here is the central and essential difference between ion exchangers that bind all cations non-selectively and the MetCap-T chelate resin that binds heavy metals out of the solution selectively or with a strong preference.

As can be demonstrated from the aforementioned embodiments, none of the components listed is suitable on its own to address the complex and multi-layered impurity profiles, or like reverse osmosis (RO), entails serious disadvantages.

For this reason, there are already a number of manufacturers in the market with devices that combines several of the technologies listed. Just one example is the device demonstrated in CN 206359334 U in which a particle filter, a chelating resin, and an ultrafiltration unit are combined. In this case, the “chlorine” taste and organic micropollutants are not eliminated.

Many of the devices have a coarse particle filter on the input side. This serves to protect the connected device from dirt particles, and thus from clogging, and increased pressure as well as the associated reduction in productivity. A serious disadvantage of many of the purification modules listed is biofilm formation, which (as with activated carbon and the ion exchanger) can have many negative consequences, some of which can be mentioned here: reduced capacity, loss of filtration performance, increase in pressure, reduced productivity, contamination of the drinking water with harmful bacteria and/or their toxic metabolites, in general, a drop in the quality of the drinking water.

Therefore, there was a need to overcome the aforementioned disadvantages of the existing technology.

This task has been achieved by a device for multi-stage, modular purification of drinking water, wherein a module comprises a chelating gel or a chelating and bactericidal gel for the removal of heavy metal or for the removal of heavy metal and bacteria.

According to one embodiment, the device can consist of a combination of different independent modules or cartridges which are connected to each other via pipes or directly.

The device combines and simplifies different orthogonal water purification technologies in a manner that satisfies the highest quality requirements by addressing different contaminant spectra successively.

The cartridges have an inlet opening through which the water from the pipe system/tap or an upstream cartridge enters the cartridge and comes into contact with the respective cartridge filling. In addition, the cartridge has an outlet opening through which the processed, purified water flows into the next cartridge or reaches the removal point.

Preferably, the cartridges are connected to each other and fixed in the device in such a way that they can be removed, replaced, or regenerated separately.

The device operates at a pipeline pressure of preferably 0.5-6 bar, more preferably 1-5 bar, most preferably 2-4 bar.

The core of the devices demonstrated here is a cartridge filled with a chelating MetCap-T resin to remove toxic heavy metals with and without a bactericidal function. If a bactericidal variant of the MetCap-T resins is used, as demonstrated in DE patent application 10 2017 007 273.6, then additional units for removing bacteria are unnecessary.

The central cartridge can be combined with a number of other cartridges that each address specific contaminant spectra that are not addressed by the chelating resin. These cartridges can be upstream or downstream of the central MetCap-T cartridge.

Furthermore, the entire device can be connected to a tank or directly to an extraction valve. The device can also be used as a component in a water heating system.

Because of the regeneration that is frequently becoming necessary, the cartridge with the ion exchange resin is provided with a device for easy regeneration. This is accomplished by rinsing with concentrated saline. In a preferred embodiment, the need for regeneration is determined by the appropriate sensors (such as water hardness, conductivity, flow cell, etc.) and indicated by warning lights.

Regeneration can be manual, semi-automatic, or automatic, depending on whether the device is equipped with appropriate sensors and storage tanks for salt or saline solution in the respective embodiment. In a preferred embodiment, the water softening module is equipped with the appropriate connections and valves for this purpose. The surplus salt is disposed of directly through the spout into the sewer or through the extraction valve.

For all other cartridges, regeneration is not possible and/or is technically not feasible with household products.

In a preferred embodiment of the device, the input of the particle filter is connected to the water supply system, the output of which is connected to the input of the activated carbon filter, the output of which in turn is connected to the input of the water softening module, the output of which is connected to the MetCap cartridge, the output of which in turn is connected to the RO module, the output of which then flows into the extraction point (see FIG. 1). When the water pressure on the input side of the device is low, a pump is connected.

Alternatively, the particle filter can be connected directly to the activated carbon filter, then to the MetCap cartridge, and finally to the RO module (see FIG. 2).

In the last two embodiments, the order of the MetCap cartridge and the water softener can also be reversed.

In a further preferred embodiment, the particle filter is connected to the activated carbon cartridge that is connected to the water softening module and then to the MetCap cartridge, followed by a UF membrane (see FIG. 3). Alternatively, the particle filter can also be connected directly to the activated carbon cartridge, the MetCap cartridge, and the UF membrane (see FIG. 4). If necessary, the water softening module can also be installed upstream of the MetCap cartridge. The advantages of this embodiment are that usually no pump is necessary because the device has such low back pressure that the pipeline pressure is sufficient for regular operation.

In a further preferred embodiment, the particle filter is connected to the activated carbon cartridge and the water softening cartridge, which in turn is connected to the MetCap cartridge, which contains a chelating and bactericidal gel (see FIG. 5).

Alternatively, the particle filter can also be connected directly to the activated carbon cartridge, and the latter directly to the MetCap cartridge filled with a chelating and bactericidal gel (see FIG. 6).

In this embodiment, further bacteria removal membranes can be dispensed with.

In a further preferred embodiment, the particle filter is connected directly to the water softening cartridge, and the latter is connected directly to the MetCap cartridge, filled with a chelating and bactericidal gel (see FIG. 7).

In a further embodiment of the device, the particle filter is connected directly to the MetCap cartridge, filled with a chelating and bactericidal gel (see FIG. 8). This embodiment is similar to the cartridge demonstrated in DE 102016007662 A1, but differs from it in its filling with a chelating and bactericidal gel.

The device can be easily combined with all other common purification or storage modules, such as an adjacent tank for storing the purified water, or other purification technologies, such as UV disinfection (in the tank or online), redox filters, etc., or for further use in hot-water preparation, a CO₂ additive module for the production of sparkling water, a possible chlorination or hydrogen peroxide additive for subsequent disinfection or preservation, etc.

The device does not affect or interfere with the type of subsequent water extraction or water treatment.

The performance of the device can be monitored by suitable sensors at a suitable location, either at the extraction point or at points between the individual modules. Examples of suitable sensors include, but are not limited to, pH sensors, conductivity sensors, bacteria concentration detection sensors, ion selective sensors, UV sensors, etc. A flow cell can measure the amount of water processed.

In a preferred embodiment, the sensors are connected to a data processing system that monitors the function of the individual modules based on the measured values and issues the appropriate messages when a cartridge has to be replaced or regenerated. With the aid of the sensors, the replacement of the modules can also be purely time-controlled or volume-controlled. Depending on the embodiment, the data processing system can initiate automatic regeneration of the water softening module or close a valve to force the replacement of modules as a prerequisite for continued operation.

For the first time, the devices described herein allow a comprehensive purification of drinking water as a simple solution for a household, which is superior to all known systems in terms of the quality of the purified water and the yield or energy consumption.

On the one hand, the devices concentrate on the removal of really harmful, partially toxic substances, and on the other hand, on the general improvement of the water quality by improving the taste (for example, by removing the “chlorine”).

In the smallest version, the device is suitable for use in the home and is based on typical consumption. In larger versions, the device can also be used in multiple dwellings, residential complexes, restaurants, hospitals, on ships, or in other facilities with a need for high-quality drinking water.

Accordingly, another object of the invention is the use of the aforementioned devices for the purification of drinking water.

### LIST OF FIGURES

The following figures serve to further explain the invention. They show the following:

FIG. 1: Schematic structure of the device for water purification with particle filter, activated carbon module, water softening module, MetCap module, and RO membrane module.

FIG. 2: Schematic structure of the device for water purification with particle filter, activated carbon module, MetCap module, and RO membrane module.

FIG. 3: Schematic structure of the device for water purification with particle filter, activated carbon module, water softening module, MetCap module, and UF membrane module.

FIG. 4: Schematic structure of the device for water purification with particle filter, activated carbon module, MetCap module, and UF membrane module.

FIG. 5: Schematic structure of the device for water purification with particle filter, activated carbon module, water softening module, and MetCap module with additional bactericidal function.

FIG. 6: Schematic structure of the device for water purification with particle filter, activated carbon module, and MetCap module with additional bactericidal function.

FIG. 7: Schematic structure of the device for water purification with particle filter, water softening module, and MetCap module with additional bactericidal function.

FIG. 8: Schematic structure of the device for water purification with particle filter and MetCap module with additional bactericidal function.

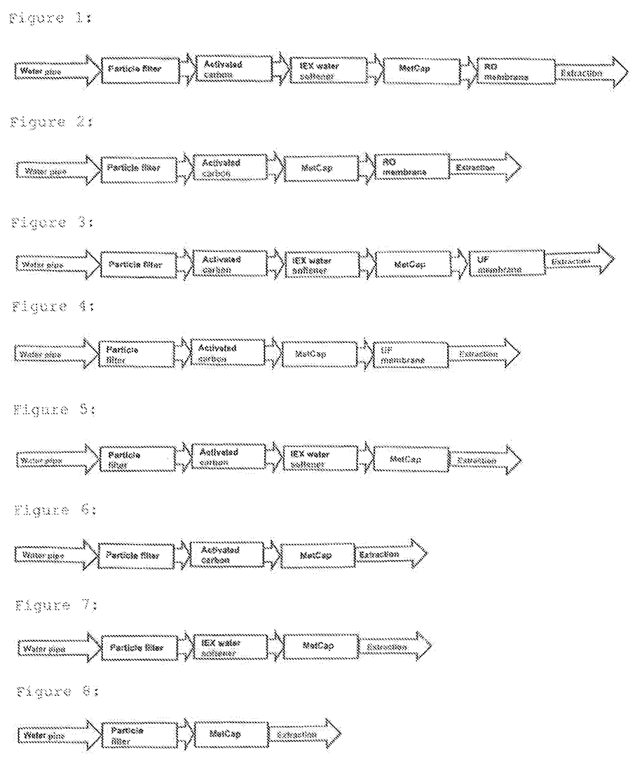

1. Device for the multi-stage, modular purification of drinking water, wherein one module comprises a chelating gel or a chelating and bactericidal gel for the removal of heavy metal or for the removal of heavy metal and bacteria.

2. Device according to claim 1, wherein the module for the removal of heavy metal is connected in series to other modules.

3. Device according to claim 1 wherein the following modules are connected in series:
particle filter, active carbon, water softener, chelating gel, RO membrane;
particle filter, active carbon, water softener, chelating gel, UF membrane;
particle filter, active carbon, water softener, chelating and bactericidal gel;
particle filter, active carbon, chelating gel, RO membrane;
particle filter, active carbon, chelating gel, UF membrane; or
particle filter, active carbon, chelating and bactericidal gel.

4. Device according to claim 1, wherein the device can be connected directly to the tap water system and operated with pipeline pressure when no RO module is used.

5. Device according to claim 1, wherein the device is additionally equipped with a pump when an RO module is used.

6. Device according to claim 1, wherein the modules can be replaced or regenerated independently of each other.

7. Device according to claim 1, wherein the water softening module comprises a device for automatic, semi-automatic, or manual regeneration.

8. Device according to claim 1, wherein the device comprises a pH sensor, a conductivity sensor, a UV sensor, or sensors for bacteria determination.

9. Device according to claim 1, wherein the sensors issue a warning when defined limits are exceeded or undershot.

10. Device according to claim 1, wherein the device comprises additional elements.

11. Device according to claim 10, wherein the additional elements are selected from a water tank, a water heating system, a (UV) disinfection system, a redox filter, a CO₂ dosing unit, or a chlorination unit.

12. Use of a device according to claim 1 for the purification of drinking water.
